(19) United States
(12) Patent Application Publication
(10) Pub. No.: US 2026/0268866 A1
(43) Pub. Date: Sep. 10, 2026

(54) ELECTRONIC DEVICE AND METHOD FOR UPDATING IMAGES

(71) Applicant: MediaTek Singapore Pte. Ltd., Singapore (SG)

(72) Inventors: Yanbin LIU, Anhui (CN); Fuguo LI, Anhui (CN); Guoxing WANG, Anhui (CN)

(21) Appl. No.: 19/095,846

(22) Filed: Mar. 31, 2025

(30) Foreign Application Priority Data
Mar. 4, 2025 (CN) 202510255291.7

(51) Int. Cl. G09G 3/34

(52) U.S. Cl. CPC G09G 3/344; G09G 2360/08; G09G 2360/18

(57) ABSTRACT

An electronic device is provided. The electronic device includes an electrophoretic display, a memory, and a central processing unit (CPU). The electrophoretic display has a first mode and a second mode. The memory includes a first buffer and a second buffer. The first buffer stores a first bit corresponding to a first image, and the second buffer stores a second bit corresponding to a second image. The CPU controls the electrophoretic display to update the first image using the first mode in response to a determination that the first bit in the first buffer is a certain value while the electrophoretic display is updating the second image using the second mode.

### CROSS REFERENCE TO RELATED APPLICATIONS

This Application claims priority of China Patent Application No. 202510255291.7, filed on Mar. 4, 2025, the entirety of which is incorporated by reference herein.

### BACKGROUND OF THE INVENTION

### Field of the Invention

The present invention relates to an electrophoretic display, and, in particular, to the control of an electrophoretic display with at least two modes.

### Description of the Related Art

Many e-book readers (also referred to as e-readers) are able to switch between two modes (Such as normal reading mode, fast refresh mode, handwriting mode, video mode, display mode, power saving mode, night mode, color mode, etc.). Due to the characteristics of the display of the e-readers, it takes a plurality of frames to show an image on the display. It is necessary to complete all the images in one mode before the e-reader can enter another mode. Thus, the e-reader has to wait until all images have been updated before switching to another mode, and switching modes will take a large amount of time. This will negatively impact the user experience. Solutions to the aforementioned problem are required.

### BRIEF SUMMARY OF THE INVENTION

An embodiment of the present invention provides an electronic device. The electronic device comprises an electrophoretic display, a memory, and a central processing unit (CPU). The electrophoretic display has a first mode and a second mode. The memory comprises a first buffer and a second buffer. The first buffer is configured to store a first bit corresponding to a first image, and the second buffer is configured to store a second bit corresponding to a second image. The CPU is configured to control the electrophoretic display to update the first image using the first mode in response to a determination that the first bit in the first buffer is a certain value while the electrophoretic display is updating the second image using the second mode.

An embodiment of the present invention provides a method for updating images. The method is implemented in an electronic device comprising an electrophoretic display with a first mode and a second mode, a memory, and a CPU. The memory comprises a first buffer and a second buffer. The method comprises storing a first bit corresponding to a first image in the first buffer and storing a second bit corresponding to a second image in the second buffer. The method comprises controlling the electrophoretic display to update the first image using the first mode in response to a determination that the first bit in the first buffer is a certain value via the CPU while the electrophoretic display is updating the second image using the second mode.

### BRIEF DESCRIPTION OF THE DRAWINGS

The present invention can be more fully understood by reading the subsequent detailed description and examples with references made to the accompanying drawings, wherein:

FIG. 1 is the block diagram of the electronic device in accordance to the embodiments of the present disclosure;

FIGS. 2A, 2B are schematic diagrams of the method for updating the image in accordance to the embodiments of the present disclosure;

FIG. 3 is the flow diagram of method for updating the image in accordance to the embodiments of the present disclosure; and

FIG. 4 is the flow diagram of method for updating the image in accordance to the embodiments of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

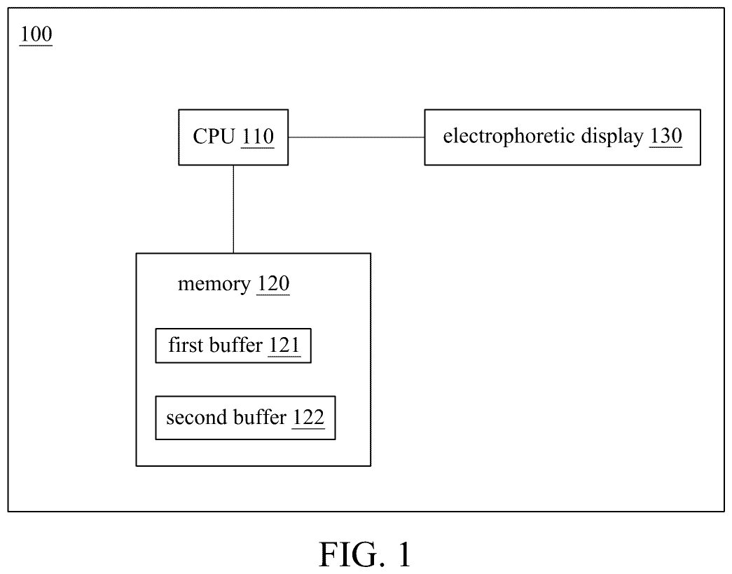

FIG. 1 is the block diagram of the electronic device 100 in accordance to the embodiments of the present disclosure. The electronic device 100 may perform various functions to implement processes and methods described herein. For example, the electronic device 100 may be an e-reader, a mobile device, or a tablet computer. The electronic device 100 may be implemented in the form of one or more integrated-circuit (IC) chips. The electronic device 100 comprises a central processing unit (CPU) 110, a memory 120, and an electrophoretic display 130. The electronic device 100 may further comprise other components, such as a battery, a transceiver, a direct memory access (DMA), or a graphics processing unit (GPU).

The CPU 110 provides the required process and calculation capability to implement the method of the embodiments. For example, the CPU 110 may provide the process and calculation capability to perform operating systems, programs, software, modules, applications, and functions. In some embodiments, the CPU 110 may be implemented in the form of hardware with electronic components, such as transistors, diodes, capacitors, resistors, or inductors. These components are configured and arranged to achieve specific purposes in accordance with the embodiments of the present disclosure.

The memory 120 stores data required by the CPU 110. The memory 120 may include non-volatile memories, such as read only memory (ROM), flash memory, hard disk drive, and solid-state disk. The memory 120 may also include volatile memories, such as dynamic random access memory (DRAM), static random access memory (SRAM) and D flip-flop array. In some embodiments, the memory 120 comprises the first buffer 121 and the second buffer 122. In some embodiments, the memory 120 stores at least one program instruction, such as computer-readable instruction. When the program instruction is read and executed by the CPU 110, the program instruction causes the CPU 110 to implement software, modules, applications, functions, and methods according to the embodiments of the present disclosure.

The electrophoretic display 130 updates (draws) and display images under the control of the CPU 110. In some embodiments, the electrophoretic display 130 has a first mode and a second mode. For example, the first mode or the second mode is normal reading mode, fast refresh mode, handwriting mode, video mode, display mode, power saving mode, night mode, or color mode, etc.. The electrophoretic display 130 may include electrodes and particles with different colors. The electrophoretic display 130 displays different colors via applying different voltages to the electrodes to make the particles move. The electrophoretic display 130 applies a sequence of voltages to the electrodes so as to switch from one color to another color or display different colors. Specifically, the electrophoretic display 130 applies a sequence of voltages with different levels (positive or negative) and durations in certain order, so as to switch from one color to another color and display different colors. The first mode and the second mode may have different sequences of voltages. In some embodiments, the electrophoretic display 130 have a read mode and a write mode. In the write mode, the user can write and leave their handwriting on the electrophoretic display 130. While the user can't write on the electrophoretic display 130 in the read mode. In some embodiments, the colors of the read mode are more vibrant. The color contrast of the read mode is more obvious. The latency of displaying an image is shorter in the write mode, and the sequences of voltages may be shorter in the write mode. In some embodiments, the electrophoretic display 130 may display the first image using the first mode and display the second image using the second mode at the same time.

Because the electrophoretic display 130 has to apply a sequence of voltages to display different colors, it takes a plurality of frames (e.g. a period of time) to completely update or display an image on the electrophoretic display 130. Furthermore, because the first mode and the second mode have different sequence of voltages, the CPU 110 has to know the mode of an image (first mode or second mode), so as to control the electrophoretic display 130 to update the image using the corresponding sequence of voltages. Thus, when the electrophoretic display 130 switches from one mode to another mode, the electrophoretic display 130 has to wait until all images of one mode have been updated before switching to another mode. Switching between different modes takes a large amount of time.

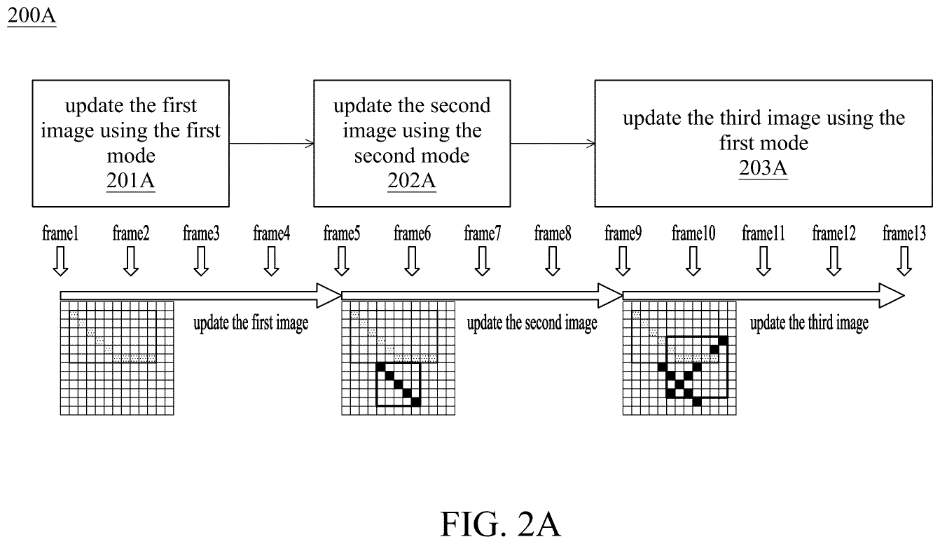

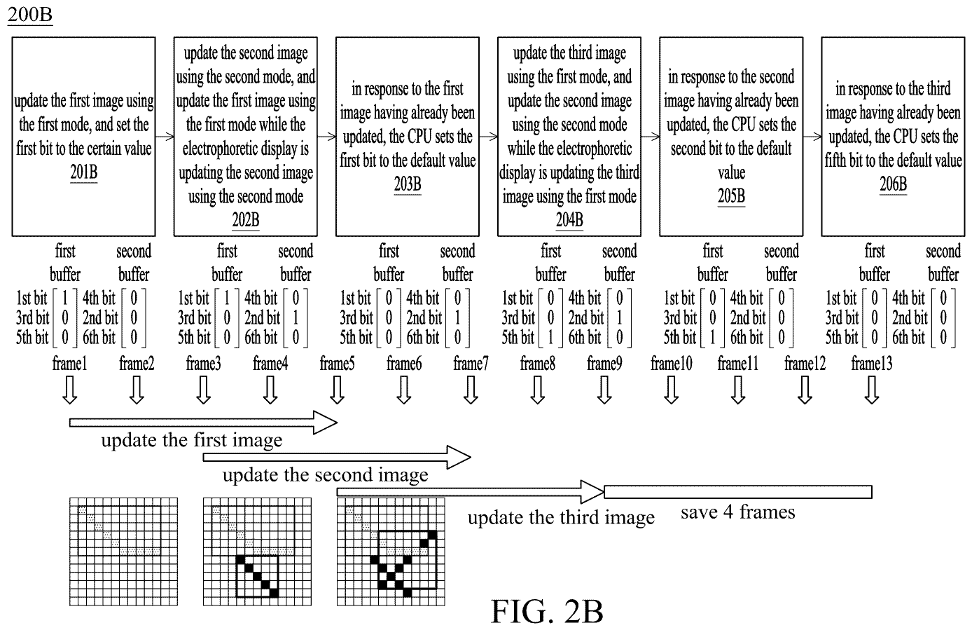

Refer to FIG. 2A, FIG. 2A is a schematic diagram of the method 200A for updating the image in accordance to the embodiments of the present disclosure. Method 200A may be implemented in the electronic device 100. In operation 201A, the CPU 110 controls the electrophoretic display 130 to update the first image using the first mode (using the sequence of voltage of the first mode). It takes four frames for the electrophoretic display 130 to update the first image. In operation 202A, the CPU 110 controls the electrophoretic display 130 to update the second image using the second mode, after the first image has been updated. It takes four frames for the electrophoretic display 130 to update the second image. In operation 203A, the CPU 110 controls the electrophoretic display 130 to update the third image using the first mode, after the second image has been updated.

Refer to FIG. 2B, FIG. 2B is a schematic diagram of the method 200B for updating the image in accordance to the embodiments of the present disclosure. Method 200B may be implemented in the electronic device 100. Method 200B may be referred to as a latency reduction mode. In this embodiment, the first buffer 121 is configured to store the first bit corresponding to the first image, and the second buffer 122 is configured to store the second bit corresponding to the second image. In some embodiments, the first buffer 121 is further configured to store the third bit corresponding to the second image, and the second buffer 122 is further configured to store the fourth bit corresponding to the first image. In some embodiments, the first buffer 121 is further configured to store the fifth bit corresponding to the third image, and the second buffer 122 is further configured to store the sixth bit corresponding to the third image. In operation 201B (frame 1), the CPU 110 controls the electrophoretic display 130 to update the first image using the first mode. In response to the first image updating (using the first mode), the CPU 110 set the first bit to the certain value, such as “1”.

In operation 202B (frame 3), the CPU 110 controls the electrophoretic display 130 to update the second image using the second mode. Furthermore, the CPU 110 controls the electrophoretic display 130 to update the first image using the first mode in response to a determination that the first bit in the first buffer 111 is the certain value, while the electrophoretic display 130 is updating the second image using the second mode. It is noted that, in this embodiment, the first image and the second image are updated using different modes at the same time, and the CPU 110 doesn't wait until the first image has been updated before starting to update the second image. In response to the second image updating (using the second mode), the CPU 110 set the second bit to the certain value, such as “1”. In operation 203B (frame 5), in response to the first image having already been updated, the CPU 110 sets the first bit to the default value, such as “0”.

In operation 204B (frame 5), the CPU 110 controls the electrophoretic display 130 to update the third image using the first mode. Furthermore, the CPU 110 controls the electrophoretic display 130 to update the second image using the second mode in response to a determination that the second bit in the second buffer 122 is the certain value, while the electrophoretic display 130 is updating the third image using the first mode. In response to the third image updating (using the first mode), the CPU 110 set the fifth bit to the certain value, such as “1”. The second image and the third image are updated using different modes at the same time, and the CPU 110 doesn't wait until the second image has been updated before starting to update the third image. In operation 205B (frame 7), in response to the second image having already been updated, the CPU 110 sets the second bit to the default value, such as “0”. In operation 206B (frame 9), in response to the third image having already been updated, the CPU 110 sets the fifth bit to the default value, such as “0”. As shown, in the FIGS. 2A and 2B, method 200B saves 4 frames. In the practical application, it may take 10~128 frames to update an image. Thus, method 200B can save a large amount of time and significantly reduce latency between mode switching.

Thus, when the bit corresponding to one image is set to the certain value, it means that the image is still updating. Furthermore, the CPU 110 can determine whether the image is being updated using the first mode or the second mode based on the bit corresponding to the image set to the certain value is stored in the first buffer 121 or the second buffer 122. For example, the electrophoretic display 130 is in the first mode. At this time, if a bit in the first buffer 121 is set to the certain value, it means that the image corresponding to the bit is being updated using the currently used mode (i.e. the first mode). Then, the electrophoretic display 130 may switch to the second mode. At this time, if a bit in the first buffer 121 is set to the certain value, it means that the image corresponding to the bit is being updated using the previously used mode (i.e. the first mode). If a bit in the second buffer 122 is set to the certain value, it means that the image corresponding to the bit is being updated using the currently used mode (i.e. the second mode). Then, the electrophoretic display 130 may switch to the first mode. At this time, if a bit in the first buffer 121 is set to the certain value, it means that the image corresponding to the bit is being updated using the currently used mode (i.e. the first mode). If a bit in the second buffer 122 is set to the certain value, it means that the image corresponding to the bit is being updated using the previously used mode (i.e. the second mode).

It should be noted that the above description is just an example and should not be used to limit the present disclosure. In the above description, the first buffer 121 can be replaced with the second buffer 122, and the second buffer 122 can be replaced with the first buffer 121. For example, when the image is being updated using the first mode, the bit corresponding to the image in the second buffer 122 may be set to the certain value.

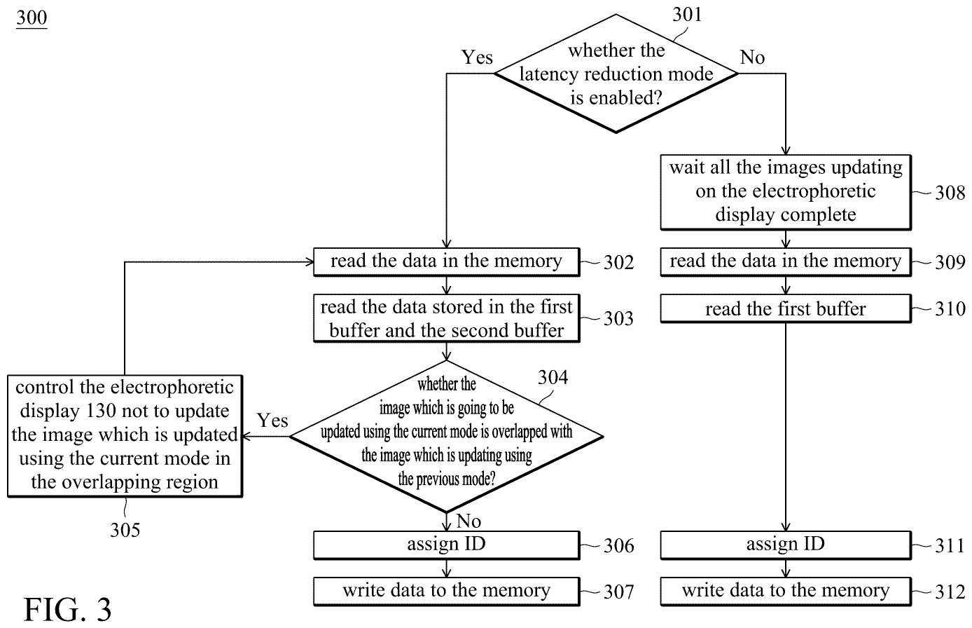

Refer to FIG. 3, FIG. 3 is the flow diagram of method 300 for updating the image in accordance to the embodiments of the present disclosure. Method 300 may be implemented in the electronic device 100. In operation 301, the CPU 110 determines whether the latency reduction mode is enabled. When the latency reduction mode is enabled, the CPU 110 performs operation 302. When the latency reduction mode is not enabled, the CPU 110 performs operation 308.

In operation 302, the CPU 110 reads the data in the memory 120. Specifically, the CPU 110 reads the DRAM via the DMA. The CPU 110 may read two positions of DRAM. One position of the DRAM stores the information of the pixel which is going to be write. Another position of the DRAM stores the information of the image which is going to be updated on the pixel. For example, in addition to the first buffer and the second buffer, the memory 120 further comprises a working buffer and an image buffer. The working buffer is for storing the information of the pixel which is going to be write and the image buffer is for storing the information of the image which is going to be updated on the pixel. A person having ordinary skills in the art could know that this embodiment takes the working buffer and the image buffer inside the memory 120 as an example. The working buffer and the image buffer may also be the registers inside the CPU 110.

In operation 303, the CPU 110 reads the data stored in the first buffer 121 and the second buffer 122. For example, refer to FIG. 2B, the CPU 110 may read the first, second, third, fourth, fifth, and sixth bit, before controlling the electrophoretic display 130 to update the first image and the second image. Then, the CPU 110 may determine the mode (first mode or second mode) of the images corresponding to these bits according to the value of these bits. For example, the first bit with the value 1 means the image corresponding to the first bit is active, and this image may not be updated; the third bit with the value 0 means the image corresponding to the third bit is not active, and this image may be updated. In some embodiments, the number of bits stored in each of the first buffer 121 and the second buffer 122 equals to the number of the maximum number of images that the electrophoretic display 130 can display. In some embodiments, the correspondence between the bit and the image is managed and stored using a software module implemented by the CPU 110. Furthermore, the state of the images (whether the image is still updating or has already completed) may be monitored using the software module. The software module may also be configured to generate or determine the images going to be displayed.

In operation 304, the CPU 110 determines whether the image which is going to be updated using the current mode is overlapped with the image which is updating using the previous mode. If two images overlap, the CPU 110 performs operation 305. If two images don't overlap, the CPU 110 performs operation 306. In operation 305, the CPU 110 controls the electrophoretic display 130 not to update the image which is updated using the current mode in the overlapping region. The electrophoretic display 130 may still update the image which is updated using the current mode on other religions of the electrophoretic display 130. In some embodiments, the CPU 110 controls the electrophoretic display 130 to update image which is updated using the current mode in the overlapping region, after the image which was updating using the previous mode has already been updated. In other words, the CPU 110 waits the update of the overlapping region is completed and then update the image which is updated using the current mode in the overlapping region.

For example, refer to FIG. 2B, the CPU 110 may first control the electrophoretic display 130 to update the first image using the first mode. Then, the CPU 110 may control the electrophoretic display 130 to update the second image using the second mode. The CPU 110 determines whether the display region of the first image on the electrophoretic display 130 and the display region of the second image on the electrophoretic display 130 overlap in the overlapping region. Then, the CPU 110 controls the electrophoretic display 130 not to update the second image in the overlapping region of the electrophoretic display 130. The CPU 110 controls the electrophoretic display 130 to update the second image in the overlapping region, after the first image has already been updated.

In operation 306, the CPU 110 assigns an identification (ID) to the image. Specifically, the CPU 110 may assign new IDs to the images which are going to be updated using the current mode. For example, the images corresponding to the bits with the value 0 may be assigned with new IDs. In operation 307, the CPU 110 writes the data to the memory 120. The CPU 110 may write the data obtained in operation 302 and the ID information obtained in operation 306 to an address of the DRAM via the DMA, and the address of the DRAM corresponding to the pixels of the electrophoretic display 130 which are going to be updated. The CPU 110 may determine the sequence of voltages of the pixels based on the written information.

In operation 308, the CPU 110 waits all the images updating on the electrophoretic display 130 complete. In operation 309, the CPU 110 reads the data in the memory 120. In operation 310, the CPU 110 reads the first buffer 121. In operation 310, the CPU 110 reads the data stored in the first buffer 121. For example, refer to FIG. 2B, the CPU 110 may read the first, second, third, fourth, fifth, and sixth bit, before controlling the electrophoretic display 130 to update the first image and the second image. Then, the CPU 110 may determine the mode (first mode or second mode) of the images corresponding to these bits according to the value of these bits. In some embodiments, the number of bits stored in each of the first buffer 121 equals to the number of the maximum number of images that the electrophoretic display 130 can display. In operation 311, the CPU 110 assigns an ID to the image. For example, the images corresponding to the bits with the value 0 may be assigned with new IDs. In operation 312, the CPU 110 writes the data to the memory 120. The CPU 110 may write the data obtained in operation 309 and the ID information obtained in operation 311 to an address of the DRAM via the DMA, and the address of the DRAM corresponding to the pixels of the electrophoretic display 130 which are going to be updated. The CPU 110 may determine the sequence of voltages of the pixels based on the written information. Operation 309 is similar to operation 302, operation 311 is similar to operation 306, and operation 312 is similar to operation 307.

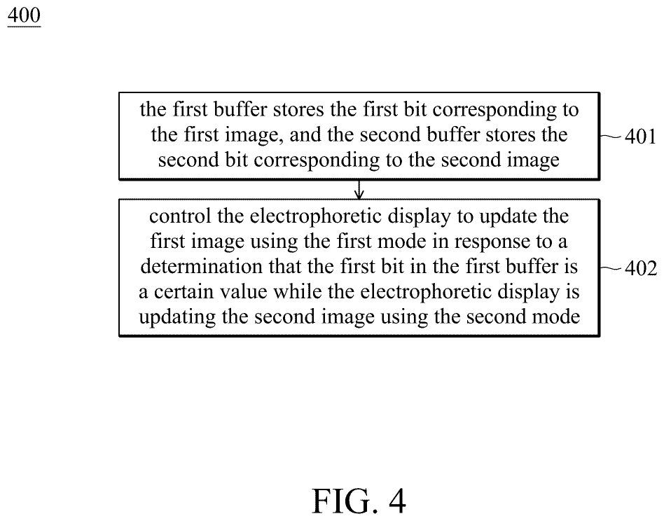

Refer to FIG. 4, FIG. 4 is the flow diagram of method 400 for updating the image in accordance to the embodiments of the present disclosure. Method 400 may be implemented in the electronic device 100. In operation 401, the first buffer 121 stores the first bit corresponding to the first image, and the second buffer 122 stores the second bit corresponding to the second image. In operation 402, the CPU 110 controls the electrophoretic display 130 to update the first image using the first mode in response to a determination that the first bit in the first buffer 121 is a certain value while the electrophoretic display 130 is updating the second image using the second mode.

In some embodiments, method 400 further comprises the operation of controlling the electrophoretic display 130 to update the second image using the second mode in response to a determination that the second bit in the second buffer 122 is the certain value via the CPU 110, while the electrophoretic display 130 is updating the third image using the first mode. In some embodiments, method 400 further comprises the operation of storing the third bit corresponding to the second image in the first buffer 121 and storing the fourth bit corresponding to the second image in the second buffer 122. Method 400 further comprises the operation of reading the first bit, the second bit, the third bit, and the fourth bit, before controlling the electrophoretic display 130 to update the first image and the second image via the CPU 110.

In some embodiments, method 400 further comprises the following operation: In response to a determination that the display region of the first image on the electrophoretic display and the display region of the second image on the electrophoretic display 130 overlap in the overlapping region, the CPU controls the electrophoretic display 130 not to update the second image on an overlapping region of the electrophoretic display 130. In some embodiments, method 400 further comprises the operation of controlling the electrophoretic display 130 to update the second image in the overlapping region via the CPU 110, after the first image has already been updated. In some embodiments, method 400 further comprises the operation of setting the first bit to the certain value via the CPU, in response to the first image updating. Method 400 further comprises the operation of setting the second bit to the certain value via the CPU 110, in response to the second image updating. In some embodiments, method 400 further comprises the operation of setting the first bit to a default value, via the CPU 110, in response to the first image having already been updated. Method 400 further comprises the operation of setting the second bit to the default value, in response to the second image having already been updated via the CPU.

An electronic device and methods for updating the images are provided. The electronic device and methods record modes of the images which are updating on the display in the buffer. The electronic device and methods are able to update different image using different modes at the same time and do not need to need to wait for all picture updates to be complete. Thus, the electronic device and methods can reduce the latency.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. An electronic device, comprising:
an electrophoretic display with a first mode and a second mode;
a memory, comprising a first buffer and a second buffer, wherein the first buffer is configured to store a first bit corresponding to a first image, and the second buffer is configured to store a second bit corresponding to a second image, wherein the first buffer corresponds to the first mode and the second buffer corresponds to the second mode; and
a central processing unit (CPU), configured to:
control the electrophoretic display to update the first image using the first mode in response to a determination that the first bit in the first buffer is a certain value while the electrophoretic display is updating the second image using the second mode.

2. The electronic device as claimed in claim 1, wherein the CPU is further configured to:
control the electrophoretic display to update the second image using the second mode in response to a determination that the second bit in the second buffer is the certain value while the electrophoretic display is updating a third image using the first mode.

3. The electronic device as claimed in claim 1, wherein the first buffer is further configured to store a third bit corresponding to the second image, and the second buffer is further configured to store a fourth bit corresponding to the second image;
wherein the CPU is further configured to read the first bit, the second bit, the third bit, and the fourth bit before controlling the electrophoretic display to update the first image and the second image.

4. The electronic device as claimed in claim 1, wherein the CPU is further configured to:
control the electrophoretic display not to update the second image on an overlapping region of the electrophoretic display, in response to a determination that a display region of the first image on the electrophoretic display and a display region of the second image on the electrophoretic display overlap in the overlapping region.

5. The electronic device as claimed in claim 4, wherein the CPU is further configured to:
control the electrophoretic display to update the second image in the overlapping region after the first image has already been updated.

6. The electronic device as claimed in claim 1, wherein the CPU is further configured to:
set the first bit to the certain value, in response to the first image updating;
set the second bit to the certain value, in response to the second image updating.

7. The electronic device as claimed in claim 1, wherein the CPU is further configured to:
set the first bit to a default value, in response to the first image having already been updated; and
set the second bit to the default value, in response to the second image having already been updated.

8. A method for updating images, implemented in an electronic device comprising an electrophoretic display with a first mode and a second mode, a memory, and a central processing unit (CPU), wherein the memory comprises a first buffer and a second buffer, wherein the method comprises:
storing a first bit corresponding to a first image in the first buffer and storing a second bit corresponding to a second image in the second buffer, wherein the first buffer corresponds to the first mode and the second buffer corresponds to the second mode; and
controlling, via the CPU, the electrophoretic display to update the first image using the first mode in response to a determination that the first bit in the first buffer is a certain value while the electrophoretic display is updating the second image using the second mode.

9. The method as claimed in claim 8, further comprising:
controlling, via the CPU, the electrophoretic display to update the second image using the second mode in response to a determination that the second bit in the second buffer is the certain value while the electrophoretic display is updating a third image using the first mode.

10. The method as claimed in claim 8, further comprising:
storing a third bit corresponding to the second image in the first buffer and storing a fourth bit corresponding to the second image in the second buffer; and
reading, via the CPU, the first bit, the second bit, the third bit, and the fourth bit, before controlling the electrophoretic display to update the first image and the second image.

11. The method as claimed in claim 8, further comprising:
controlling, via the CPU, the electrophoretic display not to update the second image on an overlapping region of the electrophoretic display, in response to a determination that a display region of the first image on the electrophoretic display and a display region of the second image on the electrophoretic display overlap in the overlapping region.

12. The method as claimed in claim 11, further comprising:
controlling, via the CPU, the electrophoretic display to update the second image in the overlapping region, after the first image has already been updated.

13. The method as claimed in claim 8, further comprising:
setting, via the CPU, the first bit to the certain value, in response to the first image updating; and
setting, via the CPU, the second bit to the certain value, in response to the second image updating.

14. The method as claimed in claim 8, further comprising:
setting, via the CPU, the first bit to a default value, in response to the first image having already been updated; and
setting, via the CPU, the second bit to the default value, in response to the second image having already been updated.
